(19) United States
(12) Patent Application Publication
(10) Pub. No.: US 2007/0078646 A1
(43) Pub. Date: Apr. 5, 2007

(54) METHOD AND APPARATUS TO ENCODE/DECODE AUDIO SIGNAL

(76) Inventors: Miao Lei, Yongin-si (KR); Miyoung Kim, Suwon-si (KR); Shihwa Lee, Seoul (KR); Sangwook Kim, Seoul (KR); Dohyung Kim, Hwaseong-si (KR)

Correspondence Address: STANZIONE & KIM, LLP, 919 18TH STREET, N.W., SUITE 440, WASHINGTON, DC, 20006, US

(21) Appl. No.: 11/535,638

(22) Filed: Sep. 27, 2006

(30) Foreign Application Priority Data
Oct. 4, 2005 (KR) 2005-093119

(51) Int. Cl. G10L 19/00

(52) U.S. Cl. 704/200.1

(57) ABSTRACT

A method and apparatus to encode/decode an audio signal, in which a bit rate for each bit plane can be controlled. A method of encoding an audio signal for each of a plurality of bit plane can include dividing the audio signal into a plurality of frequency bands and encoding the bit planes of the frequency bands from a low frequency band to a high frequency band, wherein, in the encoding the bit planes of the frequency bands, the bit planes are encoded from the most significant bit (MSB) to the least significant bit (LSB) within bits allocated for the frequency bands, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded using the remaining allocated bits. Accordingly, when encoding/decoding an audio signal, an encoding sequence of bit planes is determined so that an audio signal that significantly affects audio quality during decoding is first encoded, thereby reducing audio quality deterioration at a low bit rate.

### CROSS-REFERENCE TO RELATED APPLICATIONS

This application claims the benefit of Korean Patent Application No. 10-2005-0093119, filed on Oct. 4, 2005, in the Korean Intellectual Property Office, the disclosure of which is incorporated herein in its entirety by reference.

### BACKGROUND OF THE INVENTION

1. Field of the Invention

The present general inventive concept relates to encoding and decoding an audio signal, and more particularly, a method and apparatus to encode/decode an audio signal, in which a bit rate for each bit plane can be controlled.

2. Description of the Related Art

A user can store a signal in a recording medium of an audio device in order to listen to the stored signal at a later time. With the development of digital signal processing techniques, compact disks (CDs) and digital audio tapes (DATs) have been used instead of conventional LPs and tapes, which are based on analog signals. As a result, audio quality has improved, but problems relating to data storage and data transmission have arisen due to the large amount of data required for digital audio. Therefore, methods of reducing the amount of data, such as differential pulse code modulation (DPCM) and adaptive differential pulse code modulation (ADPCM), have been introduced. However, the efficiency of such methods may vary significantly according to signal type. To solve this problem, the motion pictures experts group (MPEG) standard, introduced by the international standard organization (ISO), uses a method of reducing the amount of data by taking human psychoacoustics into account. In the above-mentioned methods, each bit string of data has a specific bit rate such as a fixed bit rate of 128 kbps. When a dedicated line supporting a specific bit rate is used for signal transmission, a signal can be transmitted at the fixed bit rate without errors. However, when a transmission line is unstable (i.e., not dedicated to supporting a specific bit rate), it is hard to analyze the signal at a receiving end. For example, if one audio frame is composed of as many as n slots, all of the n slots have to be transmitted to the receiver within a given time to obtain data without an error.

In addition, if several receivers receive data from one transmitter, and if the receivers have transmission lines with different capacities or demand different bit rates, it is hard to meet the demands of the receivers when the transmitter supports only a fixed bit rate. In this case, to properly cope with given circumstances or users' requirements, an audio signal has to be composed of an encoded bit stream having various bit rates. To this end, a method and apparatus for encoding/decoding an audio signal which can control a bit rate has been recently introduced. However, such a method and apparatus for encoding/decoding an audio signal cause significant deterioration of audio quality at a low bit rate.

### SUMMARY OF THE INVENTION

The present general inventive concept provides a method and apparatus to encode/decode an audio signal, in which a bit rate for each bit plane can be controlled to reduce audio quality deterioration at a low bit rate.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing a method of encoding an audio signal for each of a plurality of bit planes, including: dividing the audio signal into a plurality of frequency bands; and encoding the bit planes of the frequency bands from a low frequency band to a high frequency band, wherein, in the encoding the bit planes of the frequency bands, the bit planes are encoded from the most significant bit (MSB) to the least significant bit (LSB) within bits allocated for the frequency bands, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded using the remaining allocated bits

The foregoing and/or other aspects and utilities of the present general inventive concept are achieved by providing a method of encoding an audio signal for each of a plurality of bit planes, comprising: dividing the audio signal into a plurality of frequency bands; estimating values of the bit planes included in the audio signal using a scale factor, and shifting bits of the bit planes according to the estimated values; and encoding the bit planes of the frequency bands from a low frequency band to a high frequency band, wherein, in the encoding the bit planes of the frequency bands, the bit planes are encoded with bits allocated for the frequency bands from the MSB to the LSB.

The foregoing and/or other aspects and utilities of the present general inventive concept are achieved by providing a method of encoding an audio signal for each of a plurality of bit planes, comprising: dividing the audio signal into a plurality of frequency bands; estimating values of the bit planes included in the audio signal using a scale factor, and shifting bits of the bit planes according to the estimated values; and encoding the bit planes of the divided frequency bands from a low frequency band to a high frequency band, wherein, in the encoding the bit planes of the frequency bands, the bit planes are encoded from the MSB to the LSB within bits allocated for the frequency bands, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded using the remaining allocated bits.

The foregoing and/or other aspects and utilities of the present general inventive concept are achieved by providing a method of decoding an audio signal for each of a plurality of bit planes by receiving a bit stream, comprising: generating information regarding an encoding sequence of the bit planes; and generating an audio signal by decoding the bit planes from the bit stream and mapping the decoded bit planes according to the generated sequence information, wherein the encoding sequence of the bit planes is determined such that the bit planes are encoded from a low frequency band to a high frequency band using bits allocated for the frequency bands from the MSB to the LSB, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded.

The foregoing and/or other aspects and utilities of the present general inventive concept are achieved by providing a method of decoding an audio signal for each of a plurality of bit planes by receiving a bit stream, comprising: estimating values of the bit planes using a scale factor included in the bit stream, and shifting bits of the bit planes according to the estimated values; generating information regarding an encoding sequence of the bit planes; and generating an audio signal by decoding the bit planes from the bit stream and mapping the decoded bit planes according to the generated sequence information, wherein the encoding sequence of the bit planes is determined to be such that the bit planes are encoded from a low frequency band to a high frequency band using bits allocated for the frequency bands from the MSB to the LSB.

The foregoing and/or other aspects and utilities of the present general inventive concept are achieved by providing a method of decoding an audio signal for each of a plurality of bit planes by receiving a bit stream, comprising: estimating values of the bit planes using a scale factor included in the bit stream, and shifting bits of the bit planes according to the estimated values; generating information regarding an encoding sequence of the bit planes; and generating an audio signal by decoding the bit planes from the bit stream and mapping the decoded bit planes according to the generated sequence information, wherein the encoding sequence of the bit planes is determined to be such that the bit planes are encoded from a low frequency band to a high frequency band using bits allocated for the frequency bands from the MSB to the LSB, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded.

The foregoing and/or other aspects and utilities of the present general inventive concept are achieved by providing an apparatus for encoding an audio signal for each of a plurality of bit planes, comprising: a sequence information generator which determines an encoding sequence of the bit planes included in the audio signal from a low frequency band to a high frequency band and generates information regarding the encoding sequence; and an encoder which encodes the bit planes according to the encoding sequence, wherein the sequence information generator determines the encoding sequence of the bit planes such that the bit planes are encoded from the MSB to the LSB using bits allocated for the frequency bands, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded using the remaining allocated bits.

The foregoing and/or other aspects and utilities of the present general inventive concept are achieved by providing an apparatus for encoding an audio signal for each of a plurality of bit planes, comprising: a value estimating unit estimating values of the bit planes included in the audio signal using a scale factor; a bit shifter shifting bits of the bit planes according to the estimated values; a sequence determining unit determining an encoding sequence of the bit planes included in the audio signal from a low frequency band to a high frequency band; and an encoder encoding the bit planes according to the encoding sequence, wherein the sequence determining unit determines the encoding sequence such that the bit planes are encoded using bits allocated for the frequency bands from the MSB to the LSB.

The foregoing and/or other aspects and utilities of the present general inventive concept are achieved by providing an apparatus for encoding an audio signal for each of a plurality of bit planes, comprising: a value estimating unit estimating values of the bit planes included in the audio signal using a scale factor; a bit shifter shifting bits of the bit planes according to the estimated values; a sequence determining unit determining an encoding sequence of the bit planes included in the audio signal from a low frequency band to a high frequency band; and an encoder encoding the bit planes according to the encoding sequence, wherein the sequence determining unit determines the encoding sequence such that the bit planes are encoded from the MSB to the LSB using bits allocated for the frequency bands, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded using the remaining allocated bits.

The foregoing and/or other aspects and utilities of the present general inventive concept are achieved by providing an apparatus for decoding an audio signal for each of a plurality of bit planes, comprising: a sequence information generator generating information regarding an encoding sequence of the bit planes; and a decoder decoding the bit planes from the bit stream, and generating an audio signal by mapping the decoded bit planes according to the generated encoding sequence, wherein the sequence information generator determines the encoding sequence to be such that the bit planes are encoded from a low frequency band to a high frequency band using bits allocated for the frequency bands from the MSB to the LSB, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded.

The foregoing and/or other aspects and utilities of the present general inventive concept are achieved by providing an apparatus for decoding an audio signal for each of a plurality of bit planes, comprising: a sequence information generator generating information regarding an encoding sequence of the bit planes; and a decoder decoding the bit planes from the bit stream, and generating an audio signal by mapping the decoded bit planes according to the generated encoding sequence, wherein the sequence information generator comprises: a value estimating unit estimating values of the bit planes using a scale factor included in the bit stream; a bit shifter shifting bits of the bit planes according to the estimated values; and a sequence determining unit determining the encoding sequence of the bit planes to be such that the bit planes are encoded from a low frequency to a high frequency using bits allocated for the frequency bands from the MSB to the LSB.

The foregoing and/or other aspects and utilities of the present general inventive concept are achieved by providing an apparatus for decoding an audio signal for each of a plurality of bit planes, comprising: a sequence information generator generating information regarding an encoding sequence of the bit planes; and a decoder decoding the bit planes from the bit stream, and generating an audio signal by mapping the decoded bit planes according to the generated encoding sequence, wherein the sequence information generator comprises: a value estimating unit estimating values of the bit planes using a scale factor included in the bit stream; a bit shifter shifting bits of the bit planes according to the estimated values; and a sequence determining unit determining the encoding sequence of the bit planes to be such that the bit planes are encoded from a low frequency band to a high frequency band using bits allocated for the frequency bands from the MSB to the LSB, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded.

The present general inventive concept also provides a computer-readable medium having embodied thereon a computer program to execute the above-mentioned methods of encoding an audio signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of an apparatus to encode an audio signal according to an embodiment of the present general inventive concept;

FIG. 2 illustrates a method of determining an encoding sequence of bit planes performed by a sequence information generator according to an embodiment of the present general inventive concept;

FIG. 3 is a view of an example of bit planes of frequency bands;

FIG. 4 is a block diagram of the sequence information generator of FIG. 1 according to an embodiment of the present general inventive concept;

FIG. 5 illustrates a method of determining an encoding sequence of bit planes performed by a sequence information generator according to an embodiment of the present general inventive concept;

FIG. 6 is a block diagram of an apparatus to decode an audio signal according to an embodiment of the present general inventive concept; and

FIG. 7 is a block diagram of the sequence information generator of FIG. 6 according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

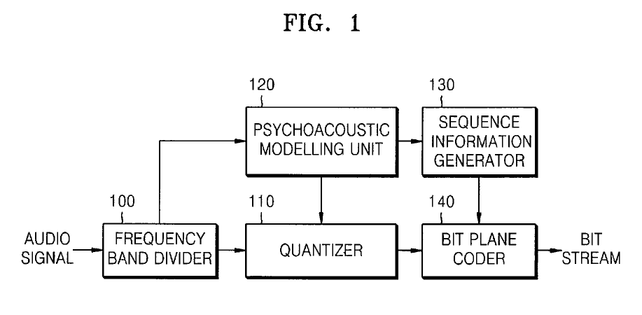

FIG. 1 is a block diagram of an apparatus to encode an audio signal according to an embodiment of the present general inventive concept. Referring to FIG. 1, the apparatus to encode an audio signal includes a frequency band divider 100, a quantizer 110, a psychoacoustic modelling unit 120, a sequence information generator 130, and a bit plane coder 140.

The frequency band divider 100 converts input audio signals in a time domain into frequency signals to be divided into a predetermined number of frequency bands in a frequency domain. The input audio signal in the time domain may be a digital signal such as a pulse code modulation (PCM) signal in an embodiment of the present general inventive concept. A sub-band filter can be included in the frequency band divider 100 to convert the PCM signal into signals for the predetermined number of frequency bands. Alternatively, instead of the sub-band filter, discrete cosine transform (DCT), modified discrete cosine transform (MDCT), or fast Fourier transform (FFT) may be used.

Characteristics of human perceptive audio signals are not very different from each other in the time domain. However, when it comes to transformed audio signals in the frequency domain, there is a significant difference between perceptible audio signals and imperceptible audio signals in a human psychoacoustics model. By considering these differences, compression efficiency can be improved by adjusting the number of bits allocated for each frequency band.

For each frequency band, the psychoacoustic modelling unit 120 estimates a masking threshold of audio signals that are converted into the frequency domain by using a masking effect. The psychoacoustic modelling unit 120 carries out signal processing to enhance encoding efficiency while minimizing changes in perceptible audio quality by using the estimated masking threshold for each frequency band. The signal processing to enhance encoding efficiency may be noise shaping in the time domain, intensity stereo processing, perceptual noise substitution processing, and mid/side (M/S) stereo processing.

The quantizer 110 scalar-quantizes the frequency signals of each frequency band such that the quantization noise level of each band is less than the masking threshold, thus removing noise. The quantized values are lossless-encoded for each bit plane by the bit plane coder 140, and then used along with additional information, such as a scale factor used for quantization, to generate a bit stream. In the generated bit stream, a predetermined number of bits is respectively allocated for each frequency band. The quantized values are encoded for each bit plane using the allocated bits besides the bits used for the additional information.

The sequence information generator 130 determines an encoding sequence of the bit planes, generates information for the determined encoding sequence, and outputs the determined encoding sequence to the bit plane coder 140. The bit plane coder 140 encodes the bit planes according to the encoding sequence.

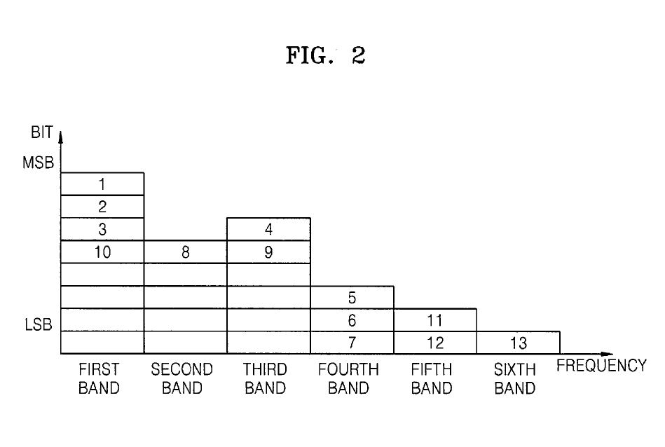

FIG. 2 illustrates a method of determining the encoding sequence of the bit planes performed by the sequence generator 130, according to an embodiment of the present general inventive concept, in which an audio signal is divided into six frequency bands, and each frequency band has one or more bit planes. In FIG. 2, numbers indicated in the bit planes denote the encoding sequence. A method of determining the encoding sequence of the bit planes performed by the sequence generator 130 will be now described in detail with reference to FIG. 2.

Bit planes are encoded using bits allocated for each frequency band, from a low frequency band to a high frequency band and from the most significant bit (MSB) to the least significant bit (LSB). If there are any remaining allocated bits after all of the bit planes of a frequency band are encoded, un-encoded bit planes of frequency bands having a lower frequency than the encoded frequency band with the remaining allocated bits are encoded using the remaining allocated bits.

Referring to FIG. 2, bit planes of a first band are encoded using bits allocated for the first band from the MSB to the LSB. Then, when there are no more bits allocated for the first band, bit planes of a second band are encoded. However, if no bits are left to encode the bit planes of the second band since the bits allocated for the second band are used for additional information, bit planes of a third band are encoded. In this way, the top three bit planes of the first band and a top bit plane of the third band are encoded. Then, bit planes of a fourth band are encoded.

When bits allocated for the fourth band remain after all the bit planes of the fourth band are encoded, bit planes corresponding to the MSB among un-encoded bit planes of the first, second, and third bands are encoded using the remaining bits. When there are two or more of the bit planes corresponding to the MSB among the un-encoded bit planes, a bit plane in a frequency band having the least encoded bit planes is encoded first using the remaining bits.

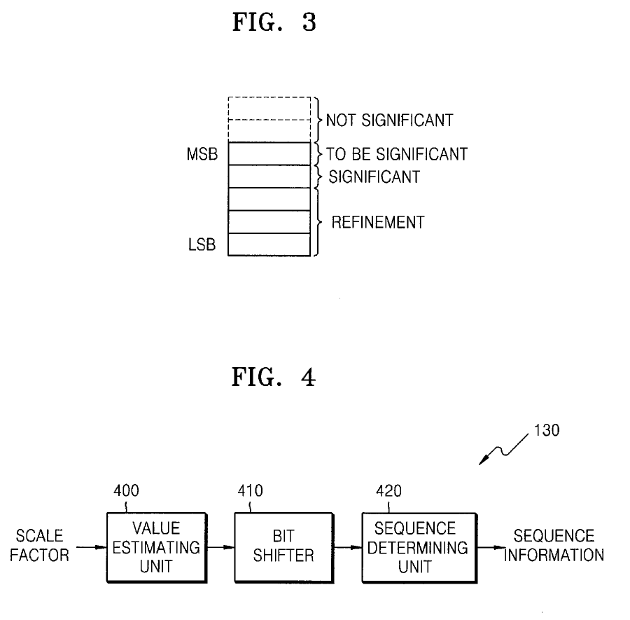

Referring to FIG. 3, bit planes are classified into “not significant”, “to be significant”, “significant”, and “refinement” according to their positions. The two or more bit planes of a frequency band are encoded in the order of “to be significant”, “significant”, and “refinement” using the remaining bits. Therefore, as illustrated in FIG. 2, the top bit plane of the second band corresponding to “to be significant” is encoded using the remaining bits of the fourth band, a bit plane second from the top of the third band corresponding to “significant” is then encoded, and a bit plane fourth from the top of the first band corresponding to “refinement” is then encoded.

Next, a fifth band is encoded from a top bit plane to a bottom bit plane, and a sixth band is then encoded.

FIG. 4 is a block diagram of the sequence generator 130 of FIG. 1, according to an embodiment of the present general inventive concept. The sequence information generator 130 of the embodiment of FIG. 4 includes a valuation estimating unit 400, a bit shifter 410, and a sequence determining unit 420.

The valuation estimating unit 400 estimates the values of bit planes to be encoded using a scale factor “scf” according to Equation 1.
value=┌k×Δscf┐ Equation 1

Here, k denotes a constant that is determined by a scale factor unit and a quantizing method, ┌ ┐ denotes a rounding operator representing a minimum integer equal to or greater than a value on which it acts, and Δscf denotes a difference between a scale factor of the bit planes and a predetermined scale factor, for example, a difference between the scale factor of the bit planes and a scale factor of a first scale factor band.

The bit shifter 410 shifts the bit planes by the estimated value. The sequence determining unit 420 determines an encoding sequence of bit planes according to the method of determining the encoding sequence described with reference to FIG. 2. If the scale factor is large, a quantization error may be large. The quantization error can be minimized by maximizing the value of a bit plane when the scale factor is large, so that the bit plane is shifted up to be encoded before other bit planes.

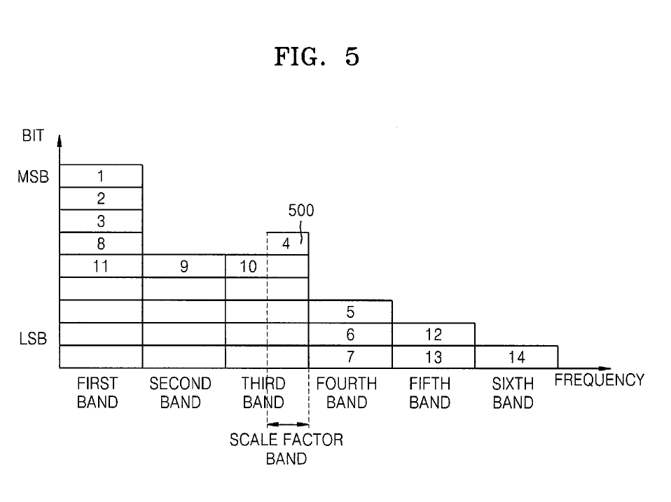

A method of determining an encoding sequence of bit planes using the aforementioned value will now be described in detail with reference to FIG. 5. When a scale factor band of the third band has a value of 1, estimated using a scale factor, bit planes of the scale factor band is shifted up by 1 bit. The top three bit planes of the first band are encoded using bits allocated for the first band, and a bit plane of the third band is encoded since no bits are allocated for the second band. At this time, a top bit plane 500 of the third band is encoded first using a bit allocated for the third band. As described above, the fourth band is encoded, a bit plane fourth from the top of the first band, which is the MSB among un-encoded bit planes of the first, second, and third bands, is encoded using one of the remaining bits of the fourth plane, a top bit plane of the second band corresponding to “to be significant” is encoded, and a second bit plane of the third band is encoded.

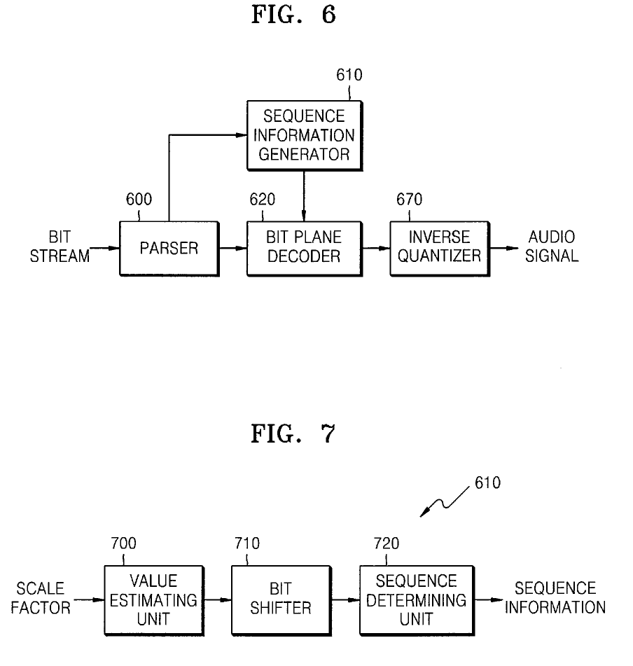

FIG. 6 is a block diagram of an apparatus to decode an audio signal, according to an embodiment of the present general inventive concept. Referring to FIG. 6, the apparatus to decode an audio signal according to this embodiment includes a parser 600, a sequence information generator 610, a bit plane decoder 620, and an inverse quantizer 670.

The parser 600 analyses an input bit stream to extract additional information and data regarding encoded bit planes from the bit stream. The sequence information generator 610 determines an encoding sequence of the bit planes in an encoding operation to generate information regarding the encoding sequence. The sequence information generator 610 determines the encoding sequence of bit planes of the bit stream in the same way that the sequence generator 130 of the apparatus to encode an audio signal determines the encoding sequence of the bit planes. Accordingly, the encoding sequence of the bit planes determined by the sequence information generator 610 coincides with the encoding sequence of an actual bit plane encoded by the apparatus to encode an audio signal.

FIG. 7 is a block diagram of the sequence information generator 610 of FIG. 6, according to an embodiment of the present general inventive concept, which is equivalent to the sequence generator 130 of the apparatus to encode an audio signal of FIG. 4. If the apparatus to decode an audio signal includes the sequence generator 130 of FIG. 4 in order to determine the encoding sequence of the bit planes, the apparatus to decode an audio signal includes the sequence information generator 610 of FIG. 6 in order to determine the encoding sequence that coincides with the encoding sequence of the actual bit plane.

Bit planes are encoded to generate a bit stream according to the encoding sequence determined by the apparatus to encode an audio signal. Thus, the encoding sequence of the bit planes determined by the sequence information generator 610 coincides with the sequence of the encoded data of each bit plane. That is, the location of encoded data of each bit plane in the bit stream can be found using the encoding sequence of the bit planes.

The bit plane decoder 620 decodes data of the encoded bit planes which are extracted by the parser 600, and maps the decoded bit planes to the frequency bands using the sequence information that is input from the sequence information generator 610. The inverse quantizer 670 inverse-quantizes the decoded bit planes into an audio signal using the extracted additional information.

In various methods and apparatuses to encode/decode an audio signal of the embodiments of the present general inventive concept which can control a bit rate, an encoding sequence of bit planes is determined so that an audio signal that significantly affects audio quality during decoding is first encoded, thereby reducing audio quality deterioration at a low bit rate.

The present general inventive concept can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of encoding an audio signal for each of a plurality of bit planes, comprising:
dividing the audio signal into a plurality of frequency bands; and
encoding the bit planes of the frequency bands from a low frequency band to a high frequency band,
wherein, in the encoding the bit planes of the frequency bands, the bit planes are encoded from the most significant bit (MSB) to the least significant bit (LSB) using bits allocated for the frequency bands, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded using the remaining allocated bits.

2. A method of encoding an audio signal for each of a plurality of bit planes, comprising:
dividing the audio signal into a plurality of frequency bands;
estimating values of the bit planes included in the audio signal using a scale factor, and shifting bits of the bit planes according to the estimated values; and
encoding the bit planes of the frequency bands from a low frequency band to a high frequency band,
wherein, in the encoding the bit planes of the frequency bands, the bit planes are encoded with bits allocated for the frequency bands from the MSB to the LSB.

3. The method of claim 2, further comprising:
performing a signal processing by using an estimated masking threshold for each frequency band after the dividing the audio signal into a plurality of frequency bands.

4. The method of claim 2, wherein the value is given by
value=┌k×Δscf┌,
where k denotes a constant that is determined by a scale factor unit and a quantizing method, ┐ ┌ denotes a raising operator, and Δscf denotes a difference between a scale factor of the bit planes and a predetermined scale factor.

5. The method of claim 4, wherein, in the shifting bits of the bit planes, bits of the bit planes are shifted by as much as the estimated value.

6. A method of encoding an audio signal for each of a plurality of bit planes, comprising:
dividing the audio signal into a plurality of frequency bands;
estimating values of the bit planes included in the audio signal using a scale factor, and shifting bits of the bit planes according to the estimated values; and
encoding the bit planes of the divided frequency bands from a low frequency band to a high frequency band,
wherein, in the encoding the bit planes of the divided frequency bands, the bit planes are encoded from the MSB to the LSB using bits allocated for the frequency bands, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded using the remaining allocated bits.

7. The method of claim 6, wherein the value is given by
value=┌k×Δscf┌,
where k denotes a constant that is determined by a scale factor unit and a quantizing method, ┌ ┐ denotes a raising operator, and Δscf denotes a difference between a scale factor of the bit planes and a predetermined scale factor.

8. A method of decoding an audio signal for each of a plurality of bit planes by receiving a bit stream, comprising:
generating information regarding an encoding sequence of the bit planes; and
generating an audio signal by decoding the bit planes from the bit stream and mapping the decoded bit planes according to the generated sequence information,
wherein the encoding sequence of the bit planes is determined such that the bit planes are encoded from a low frequency band to a high frequency band using bits allocated for the frequency bands from the MSB to the LSB, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded.

9. A method of decoding an audio signal for each of a plurality of bit planes by receiving a bit stream, comprising:
estimating values of the bit planes using a scale factor included in the bit stream, and shifting bits of the bit planes according to the estimated values;
generating information regarding an encoding sequence of the bit planes; and
generating an audio signal by decoding the bit planes from the bit stream and mapping the decoded bit planes according to the generated sequence information,
wherein the encoding sequence of the bit planes is determined to be such that the bit planes are encoded from a low frequency band to a high frequency band using bits allocated for the frequency bands from the MSB to the LSB.

10. The method of claim 8, wherein the value is given by
value=┌k×Δscf┐,
where k denotes a constant that is determined by a scale factor unit and a quantizing method, ┌ ┐ denotes a raising operator, and Δscf denotes a difference between a scale factor of the bit planes and a predetermined scale factor.

11. The method of claim 10, wherein, in the shifting bits of the bit planes, bits of the bit planes are shifted by as much as the estimated value.

12. A method of decoding an audio signal for each of a plurality of bit planes by receiving a bit stream, comprising:
estimating values of the bit planes using a scale factor included in the bit stream and shifting bits of the bit planes according to the estimated values;
generating information regarding an encoding sequence of the bit planes; and
generating an audio signal by decoding the bit planes from the bit stream and mapping the decoded bit planes according to the generated sequence information,
wherein the encoding sequence of the bit planes is determined to be such that the bit planes are encoded from a low frequency band to a high frequency band using bits allocated for the frequency bands from the MSB to the LSB, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded.

13. The method of claim 12, wherein the value is given by
value=┌k×Δscf┐,
where k denotes a constant that is determined by a scale factor unit and a quantizing method, ┌ ┐ denotes a raising operator, and Δscf denotes a difference between a scale factor of the bit planes and a predetermined scale factor.

14. An apparatus to encode an audio signal for each of a plurality of bit planes, comprising:
a sequence information generator which determines an encoding sequence of the bit planes included in the audio signal from a low frequency band to a high frequency band and generates information regarding the encoding sequence; and
an encoder which encodes the bit planes according to the encoding sequence,
wherein the sequence information generator determines the encoding sequence of the bit planes such that the bit planes are encoded from the MSB to the LSB using bits allocated for the frequency bands, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded using the remaining allocated bits.

15. An apparatus to encode an audio signal for each of a plurality of bit planes, comprising:
a value estimating unit to estimate values of the bit planes included in the audio signal using a scale factor;
a bit shifter to shift bits of the bit planes according to the estimated values;
a sequence determining unit to determine an encoding sequence of the bit planes included in the audio signal from a low frequency band to a high frequency band; and
an encoder to encode the bit planes according to the determined encoding sequence,
wherein the sequence determining unit determines the encoding sequence such that the bit planes are encoded using bits allocated for the frequency bands from the MSB to the LSB.

16. The apparatus for claim 15, wherein the value is given by
value=┌k×Δscf┐,
where k denotes a constant that is determined by a scale factor unit and a quantizing method, ┌ ┐ denotes a raising operator, and Δscf denotes a difference between a scale factor of the bit planes and a predetermined scale factor.

17. The apparatus of claim 16, wherein the bit shifter shifts bits of the bit planes by as much as the estimated values.

18. An apparatus to encode an audio signal for each of a plurality of bit planes, comprising:
a value estimating unit to estimate values of the bit planes included in the audio signal using a scale factor;
a bit shifter to shift bits of the bit planes according to the estimated values;
a sequence determining unit to determine an encoding sequence of the bit planes included in the audio signal from a low frequency band to a high frequency band; and
an encoder to encode the bit planes according to the determined encoding sequence,
wherein the sequence determining unit determines the encoding sequence such that the bit planes are encoded from the MSB to the LSB using bits allocated for the frequency bands, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded using the remaining allocated bits.

19. The apparatus of claim 18, wherein the value is given by
value=┌k×Δscf┐,
where k denotes a constant that is determined by a scale factor unit and a quantizing method, ┌ ┐ denotes a raising operator, and Δscf denotes a difference between a scale factor of the bit planes and a predetermined scale factor.

20. An apparatus to decode an audio signal for each of a plurality of bit planes, comprising:
a sequence information generator to generate information regarding an encoding sequence of the bit planes; and
a decoder to decode the bit planes from the bit stream, and to generate an audio signal by mapping the decoded bit planes according to the generated encoding sequence,
wherein the sequence information generator determines the encoding sequence to be such that the bit planes are encoded from a low frequency band to a high frequency band using bits allocated for the frequency bands from the MSB to the LSB, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded.

21. An apparatus to decode an audio signal for each of a plurality of bit planes, comprising:
a sequence information generator to generate information regarding an encoding sequence of the bit planes; and
a decoder to decode the bit planes from the bit stream, and to generate an audio signal by mapping the decoded bit planes according to the generated encoding sequence,
wherein the sequence information generator comprises:
a value estimating unit to estimate values of the bit planes using a scale factor included in the bit stream;
a bit shifter to shift bits of the bit planes according to the estimated values; and
a sequence determining unit to determine the encoding sequence of the bit planes to be such that the bit planes are encoded from a low frequency to a high frequency using bits allocated for the frequency bands from the MSB to the LSB.

22. The apparatus of claim 21, wherein the value is given by
value=┌k×Δscf┐,
where k denotes a constant that is determined by a scale factor unit and a quantizing method, ┌ ┐ denotes a raising operator, and Δscf denotes a difference between a scale factor of the bit planes and a predetermined scale factor.

23. The apparatus of claim 22, wherein the bit shifter shifts bits of the bit planes by as much as the estimated value.

24. An apparatus to decode an audio signal for each of a plurality of bit planes, comprising:
a sequence information generator to generate information regarding an encoding sequence of the bit planes; and
a decoder to decode the bit planes from the bit stream, and to generate an audio signal by mapping the decoded bit planes according to the generated encoding sequence,
wherein the sequence information generator comprises:
a value estimating unit to estimate values of the bit planes using a scale factor included in the bit stream;
a bit shifter to shift bits of the bit planes according to the estimated values; and
a sequence determining unit to determine the encoding sequence of the bit planes to be such that the bit planes are encoded from a low frequency band to a high frequency band using bits allocated for the frequency bands from the MSB to the LSB, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded.

25. The apparatus of claim 24, wherein the value is given by
value=┌k×Δscf┐,
where k denotes a constant that is determined by a scale factor unit and a quantizing method, ┌ ┐ denotes a raising operator, and Δscf denotes a difference between a scale factor of the bit planes and a predetermined scale factor.

26. A computer-readable medium having embodied thereon a computer program to execute a method comprising:
dividing the audio signal into a plurality of frequency bands; and
encoding the bit planes of the frequency bands from a low frequency band to a high frequency band,
wherein, in the encoding the bit planes of the frequency bands, the bit planes are encoded from the most significant bit (MSB) to the least significant bit (LSB) using bits allocated for the frequency bands, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded using the remaining allocated bits.

27. A computer-readable medium having embodied thereon a computer program to execute a method comprising:
dividing the audio signal into a plurality of frequency bands;
estimating values of the bit planes included in the audio signal using a scale factor, and shifting bits of the bit planes according to the estimated values; and
encoding the bit planes of the frequency bands from a low frequency band to a high frequency band,
wherein, in the encoding the bit planes of the frequency bands, the bit planes are encoded with bits allocated for the frequency bands from the MSB to the LSB.

28. A computer-readable medium having embodied thereon a computer program to execute a method comprising
dividing the audio signal into a plurality of frequency bands;
estimating values of the bit planes included in the audio signal using a scale factor, and shifting bits of the bit planes according to the estimated values; and
encoding the bit planes of the divided frequency bands from a low frequency band to a high frequency band,
wherein, in the encoding the bit planes of the divided frequency bands, the bit planes are encoded from the MSB to the LSB using bits allocated for the frequency bands, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded using the remaining allocated bits.

29. A computer-readable medium having embodied thereon a computer program to execute a method comprising:
generating information regarding an encoding sequence of the bit planes; and
generating an audio signal by decoding the bit planes from the bit stream and mapping the decoded bit planes according to the generated sequence information,
wherein the encoding sequence of the bit planes is determined such that the bit planes are encoded from a low frequency band to a high frequency band using bits allocated for the frequency bands from the MSB to the LSB, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded.

30. A computer-readable medium having embodied thereon a computer program to execute a method comprising:
estimating values of the bit planes using a scale factor included in the bit stream, and shifting bits of the bit planes according to the estimated values;
generating information regarding an encoding sequence of the bit planes; and
generating an audio signal by decoding the bit planes from the bit stream and mapping the decoded bit planes according to the generated sequence information,
wherein the encoding sequence of the bit planes is determined to be such that the bit planes are encoded from a low frequency band to a high frequency band using bits allocated for the frequency bands from the MSB to the LSB.

31. A computer-readable medium having embodied thereon a computer program to execute a method comprising:
estimating values of the bit planes using a scale factor included in the bit stream and shifting bits of the bit planes according to the estimated values;
generating information regarding an encoding sequence of the bit planes; and
generating an audio signal by decoding the bit planes from the bit stream and mapping the decoded bit planes according to the generated sequence information,
wherein the encoding sequence of the bit planes is determined to be such that the bit planes are encoded from a low frequency band to a high frequency band using bits allocated for the frequency bands from the MSB to the LSB, and when there are allocated bits remaining after the encoding of the currently encoded frequency band, un-encoded bit planes corresponding to the MSB in a frequency band that has the fewest encoded bit planes among frequency bands with a lower frequency than the currently encoded frequency band are encoded.
